(19) United States
(12) Patent Application Publication
(10) Pub. No.: US 2009/0236988 A1
(43) Pub. Date: Sep. 24, 2009

(54) ELECTRODE FOR DISCHARGE LAMP AND DISCHARGE LAMP

(75) Inventors: Shiro Iida, Kyoto (JP); Tamotsu Andou, Osaka (JP); Tatsuya Taniwaki, Osaka (JP); Katsushi Seki, Shiga (JP)

Correspondence Address: SNELL & WILMER L.L.P. (Panasonic), 600 ANTON BOULEVARD, SUITE 1400, COSTA MESA, CA, 92626, US

(73) Assignee: MATSUSHITA ELECTRIC INDUSTRIAL CO., LTD., Osaka (JP)

(21) Appl. No.: 12/299,437

(22) PCT Filed: Jun. 18, 2007
(86) PCT No.: PCT/JP2007/062244

§ 371 Date: Nov. 3, 2008

(30) Foreign Application Priority Data
Jun. 19, 2006 (JP) 2006-169204

(51) Int. Cl. H01J 61/04

(52) U.S. Cl. 313/631

(57) ABSTRACT

It is possible to obtain electrodes 15 and 16 for a discharge lamp which are compact and have a large packing capacity for electron emitting material if an electrode for a discharge lamp is structured to include a quadruple coil 50 which is made by performing a first winding of a filament 41 to make a single coil 44, performing a secondary winding of the single coil 44 to make a double coil 46, performing a tertiary winding of the double coil 46 to make a triple coil 48 and performing a quaternary winding of the triple coil 48, and, in the quadruple coil 50, at least a hollow space 47′ surrounded by the tertiary winding is structured to be packed with electron emitting material.

### TECHNICAL FIELD

The present invention relates to an electrode for a discharge lamp, and a discharge lamp. The present invention relates particularly to an electrode for a discharge lamp which is packed with electron emitting material for emitting electrons and a discharge lamp having the electrode.

### BACKGROUND ART

In recent years, demands for power saving and long life discharge lamps have been increasing. One possible method for achieving power saving is increasing the luminous efficiency by making an arc tube thinner. Making an arc tube thinner decreases electric current loss and electrode loss at the time of discharge. Therefore, luminous efficiency increases.

On the other hand, as one possible method for realizing an extension of lamp life is increasing the amount of electron emitting material with which a filament coil of an electrode is packed. FIG. 9 is a photograph showing a triple coil pertaining to a conventional example. For example, the so-called triple coil as shown in FIG. 9 is used for a conventional electrode for a discharge lamp in order to increase the packing amount of electron emitting material (Patent document 1).

FIGS. 10A, 10B and 10C describe coiling processes of the triple coil pertaining to the conventional example. Next, a description of the triple coil continues, referring to FIGS. 10A, 10B and 10c. The triple coil is manufactured as follows. Firstly, as shown in FIG. 10A, a first winding of a filament 201 is performed around a first core 202 to make a single coil 203. Next, as shown in FIG. 10B, a secondary winding of the single coil 203 is performed around a second core 204 to make a double coil 205. Furthermore, as shown in FIG. 10C, a tertiary winding of the double coil 205 is performed around a third core 206 to make the triple coil. Note that each of the cores 202, 204 and 206 is melted so as to be removed after the coiling process is complete.

According to a triple coil 207 that is manufactured in such way, not only a hollow space 202′ surrounded by the first winding but also a hollow space 204′ surrounded by the secondary winding can be packed with electron emitting material. Here, the hollow space 202′ surrounded by the first winding is where the first core 202 existed, and the hollow space 204′ surrounded by the secondary winding is where the second core 204 existed. Therefore, the triple coil 207 has a larger packing capacity for electron emitting material compared to a single coil or the like. Also, when a coil size of a triple coil becomes too large, an electrode will not be fit in an arc tube. Therefore, the number of windings in the tertiary winding which is the number of times that the double coil 205 is wound around the third core 206 is usually limited to about one turn. Therefore, as shown in FIG. 10C, the size of a hollow space 206′ surrounded by the tertiary winding is short in a winding axis direction. Here, the hollow space 206′ surrounded by the tertiary winding is where the third core 206 existed. Also, the electron emitting material is not stably kept in the hollow space 206′ surrounded by the tertiary winding. Therefore, it is difficult to pack the hollow space 206′ surrounded by the tertiary winding with the electron emitting material.

Patent Document 1: Japanese Laid-open publication No. 2004-356060

### DISCLOSURE OF THE INVENTION

### Problems to be Solved

When an attempt is made to make an arc tube thinner for saving power, a compact electrode that fits in the arc tube is needed. That is, it is possible to enhance the luminous efficiency of a lamp by making an arc tube thin and long, which makes it possible to save power. In other words, it is possible to reduce lamp power with the same brightness maintained by making an arc tube thin and long. As a result, it is possible to achieve power saving. However, since a coil size needs to be small in order to downsize an electrode, an amount of electron emitting material with which a triple coil can be packed decreases. This shortens the life of a discharge lamp.

The present invention, in view of the above problem, has a main objective to provide an electrode for a discharge lamp that is compact and has a large packing capacity for electron emitting material. The present invention has another objective to provide a power saving and long life discharge lamp having such electrode for a discharge lamp.

### Means to Solve the Problems

In order to solve the above problems, the electrode for a discharge lamp pertaining to the present invention includes a quadruple coil which is made by performing a first winding of a filament to make a single coil, performing a secondary winding of the single coil to make a double coil, performing a tertiary winding of the double coil to make a triple coil and performing a quaternary winding of the triple coil, wherein, in the quadruple coil, at least a hollow space surrounded by the tertiary winding is packed with an electron emitting material.

Also, another electrode for a discharge lamp pertaining to the present invention includes a bent triple coil which is made by performing a first winding of a filament to make a single coil, performing a secondary winding of the single coil to make a double coil, performing a tertiary winding of the double coil to make a triple coil and bending the triple coil, wherein, in the quadruple coil, at least a hollow space surrounded by the tertiary winding is packed with an electron emitting material.

The discharge lamp pertaining to the present invention has the above electrode for a discharge lamp.

### EFFECT OF THE INVENTION

The present invention has an electrode for a discharge lamp, the electrode including a quadruple coil which is made by performing a first winding of a filament to make a single coil, performing a secondary winding of the single coil to make a double coil, performing a tertiary winding of the double coil to make a triple coil and performing a quaternary winding of the triple coil, wherein, in the quadruple coil, at least a hollow space surrounded by the tertiary winding is packed with an electron emitting material. According to the stated structure, the triple coil is quaternarily wound, and increases in the coil size are suppressed even if the number of windings in the tertiary winding increases. If the number of windings in the tertiary winding increases, the length of the hollow space surrounded by the tertiary winding in the winding axis direction increases, and the function of keeping the electron emitting material is enhanced. Therefore, the hollow space surrounded by the tertiary winding can be packed with the electron emitting material. The electrode for a discharge lamp pertaining to the present invention has a quadruple coil having a small coil size and a large packing capacity for electron emitting material as mentioned above. Since the hollow space surrounded by the tertiary winding in the quadruple coil can be packed with the electron emitting material, the electrode for a discharge lamp pertaining to the present invention is compact and has a large packing capacity for electron emitting material. Specifically, the packing capacity for electron emitting material is 1.5 to 2 times larger compared to a conventional electrode.

Also, with a structure in which the tertiary winding of the quadruple coil has a mandrel diameter MD₃ of 0.15 mm to 0.45 mm, it is possible to evenly heat the entire electron emitting material at the time of discharge while ensuring the adequate packing capacity for electron emitting material. Therefore, it is possible to extend lamp life more effectively. That is, if the mandrel radius MD₃ becomes larger than 0.45 mm, the hollow space surrounded by the tertiary winding becomes so wide that it is not possible to evenly heat, in a filament, the electron emitting material with which the hollow space surrounded by the tertiary winding is packed. That is, the heat of the filament is easily conducted to apart close to the filament, which often causes overheat. On the other hand, the heat of the filament is hardly conducted to a part far from the filament, which often causes insufficient heat. As a result, the generation of free barium from the electron emitting material is interfered with. Also, the effect of extending lamp life is not achieved despite the fact that the packing amount of electron emitting material has been increased. On the other hand, when the mandrel diameter MD₃ becomes smaller than 0.15 mm, the packing capacity for electron emitting material becomes smaller because the hollow space surrounded by the tertiary winding is narrow. Therefore, with the mandrel diameter MD₃ smaller than 0.15 mm, the effect of the present invention that the packing capacity is larger than the packing capacity for the conventional triple coil is not adequately achieved.

Also, with a structure in which a coil pitch P₃ is larger than the mandrel diameter MD₃ by 1.2 to 2.4 times in the tertiary winding of the quadruple coil, it is possible to extend lamp life more effectively. That is, when the coil pitch P₃ becomes less than 1.2 times larger than the mandrel diameter MD₃, a distance between filaments that are adjacent to each other becomes too short, which causes an electrical short, causing the quadruple coil to generate insufficient heat. As a result, the generation of free barium from the electron emitting material is interfered with. Also, the effect of extending lamp life is not achieved despite the fact that the packing amount of electron emitting material has been increased. On the other hand, when the coil pitch P₃ becomes more than 2.4 times larger than the mandrel diameter MD₃, the distance between filaments that are adjacent to each other becomes too long, which might cause the electron emitting material to fall off from the hollow space surrounded by the tertiary winding due to impact and vibration caused in transporting a lamp, making the packing amount of electron emitting material insufficient.

Also, with a structure in which a second filament which is provided in addition to the filament is arranged so as to pass through at least one of a hollow space surrounded by a first winding, a hollow space surrounded by the secondary winding and the hollow space surrounded by the tertiary winding in the quadruple coil, it is possible to stably maintain the shape of the quadruple coil. Accordingly, it is possible to obtain an electrode which is made such that the electron emitting material hardly falls off and an electrical short hardly occurs.

Also, with a structure in which a diameter Da of the second filament and a diameter Db of the filament of the quadruple coil satisfy a relation of Db<Da<1.5 Db, a current appropriately splits and flows through both of the filaments since the difference is small between the diameter of the filament that composes the quadruple coil and the diameter of the second filament. Therefore, even if the filament that composes the quadruple coil is long, the total resistance value of the quadruple coil does not become very large. Thus, a discharge does not occur between electrode lead lines that support the quadruple coil even if the number of windings in the tertiary winding increases.

Also, with a structure in which a number of windings in the tertiary winding of the quadruple coil is 20 turns or more, the hollow space surrounded by the tertiary winding can be packed with an adequate amount of electron emitting material.

Also, an electrode for a discharge lamp includes a bent triple coil which is made by performing a first winding of a filament to make a single coil, performing a secondary winding of the single coil to make a double coil, performing a tertiary winding of the double coil to make a triple coil and bending the triple coil, wherein, in the quadruple coil, at least a hollow space surrounded by the tertiary winding is packed with an electron emitting material. With such structure, the same effect as in the case of using the electrode having the above-described quadruple coil can be achieved.

The discharge lamp pertaining to the present invention has the above-described electrode for a discharge lamp. Therefore, it is possible to manufacture a discharge lamp that has a small inner diameter of an arc tube and has a large packing amount of electron emitting material. Also, it is possible to obtain a power saving and long life discharge lamp. Specifically, although the rated life of a conventional discharge lamp had been 6,000 hours, the rated life of the discharge lamp pertaining to the present invention is extended to more than 10,000 hours.

### BRIEF DESCRIPTION OF THE DRAWINGS

FIG. 1 is a sectional view that shows a discharge lamp pertaining to a first embodiment;

FIG. 2 is a photograph that shows a quadruple coil pertaining to the first embodiment;

FIGS. 3A and 3B show an electrode for a discharge lamp pertaining to the first embodiment with FIG. 3A showing a front elevational view and FIG. 3B showing a side view;

FIGS. 4A, 4B, 4C and 4D show coiling processes of the quadruple coil pertaining to the first embodiment with FIG. 4A, FIG. 4B, FIG. 4C and FIG. 4D showing a first winding step, a secondary winding step, a third winding step and a quaternary winding step, respectively;

FIG. 5 is a graph showing a relation between a coil pitch P₃/a mandrel diameter MD₃ and a fall-off rate of electron emitting material;

FIG. 6 shows a comparison between specifications of a quadruple coil pertaining to the present invention and specifications of a conventional triple coil;

FIG. 7 is a partially broken view showing a structure of a lamp having electrodes for a discharge lamp pertaining to a second embodiment;

FIG. 8 shows an electrode for a discharge lamp pertaining to a modification;

FIG. 9 is a photograph showing a triple coil pertaining to a conventional example (comparative example); and

FIGS. 10A and 10B and 10C describe coiling steps of the triple coil pertaining to the conventional example (comparative example), and FIG. 10A, FIG. 10B and FIG. 10C show a first winding step, a secondary winding step and a third winding step, respectively.

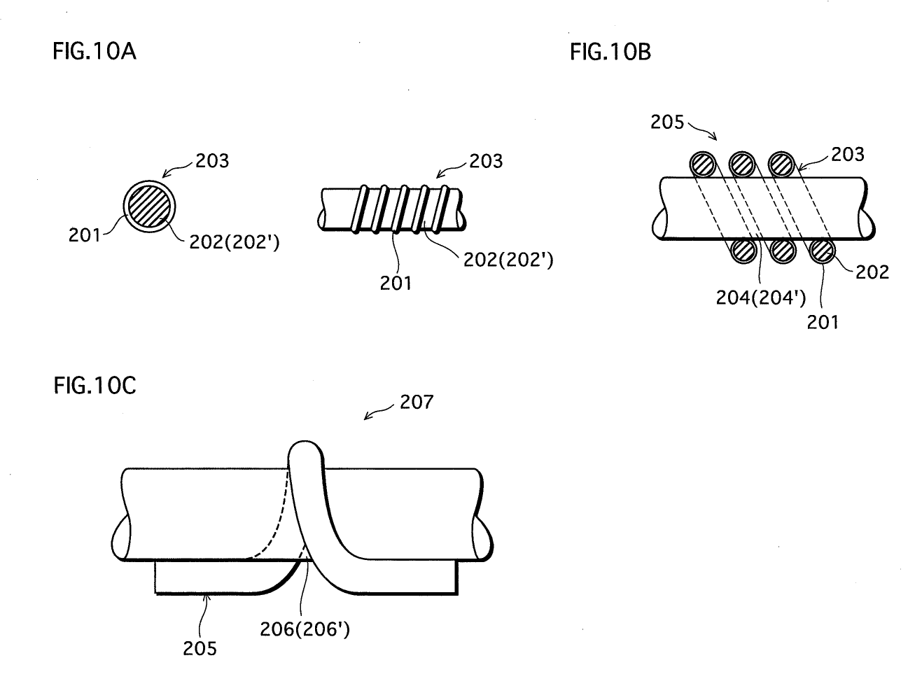

### DESCRIPTION OF NUMERAL REFERENCES

1, 100 discharge lamps
14, 110 electron emitting material
15, 16, 102, 103, 150 electrodes for discharge lamps
41 filament
42 second filament
43′ hollow space surrounded by a first winding
44 single coil
45′ hollow space surrounded by a secondary winding
46 double coil
47′ hollow space surrounded by a tertiary winding
48 triple coil
50, 105 quadruple coil
151 bent triple coil

### BEST MODE FOR CARRYING OUT THE INVENTION

Electrodes for discharge lamps pertaining to embodiments of the present invention are described based on the drawings.

### First Embodiment

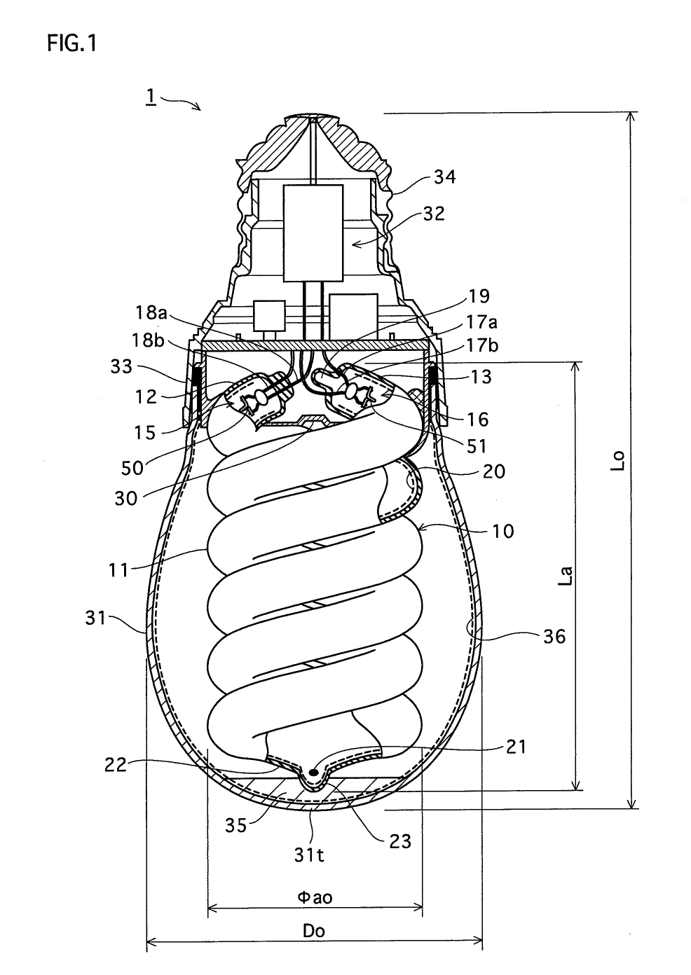

Hereinafter, a description is given of an electrode for a discharge lamp and a discharge lamp that pertain to the first embodiment using FIG. 1 to FIG. 6.

FIG. 1 is a sectional view showing the discharge lamp pertaining to the first embodiment. The discharge lamp pertaining to the first embodiment (hereinafter, shown as a “lamp”) is a bulb-type fluorescent lamp (12 W) alternative to a general incandescent lamp (60 W), and the basic structure is pursuant to a conventional lamp.

As shown in FIG. 1, a lamp 1 has an arc tube 10, a holding resin member 30 that holds the arc tube 10, an eggplant-shaped glass outer tube bulb 31 including therein the arc tube 10, an electronic ballast 32 of a so-called series inverter system for lighting that is integrally fixed to the holding resin member 30, a resin casing 33 that covers the electronic ballast 32, and a base 34 that is provided at an end portion of the resin casing 33.

The arc tube 10 is composed of a bent glass tube 11 whose container is formed and processed into a double helical form. A swollen part 22 is formed in a vicinity of the center of the bent glass tube 11 in the arc tube 10. Also, a convex part 23 is further formed on the swollen part 22. The convex part 23 is connected to a tip portion 31t of the outer tube bulb 31 by a heat conductive medium 35 made of silicon resin, and the inner surface of the end portion of the convex part 23 is designed to be the coldest point. Also, the inner surface of the outer tube bulb 31 is coated with a calcium carbonate-based diffusion membrane 36.

Electrodes 15 and 16 are disposed at both of tube end portions 12 and 13 of the arc tube 10. The electrodes 15 and 16 include quadruple coils 50 and 51 each of which is composed of a tungsten filament formed into a quaternarily wound coil, and pairs of electrode lead lines 17a and 17b and 18a and 18b that support those coils 50 and 51 using a bead mounting method. Each of the pairs of the electrode lead lines 17a and 17b and 18a and 18b is sealed airtight through both of the tube end portions 12 and 13 of the arc tube 10. Also, an exhaust tube 19 is sealed at the tube end 12 (tip portions are sealed after exhausting gas from an arc tube). Note that the detail of the electrodes 15 and 16 is described later.

A phosphor layer 20 that converts ultraviolet rays emitted by mercury into visible light is formed on the main inner surface of the arc tube 10. The phosphor layer 20 is, for example, composed of a rare earth phosphor that is a mixture of a red phosphor (Y₂O₃: Eu), a green phosphor (LaPO₄: Ce, Tb) and a blue phosphor (BaMg₂Al₁₆O₂₇: Eu, Mn).

Inside the arc tube 10, for example, single mercury (Hg) 21 of 3 mg and mixed gas (not shown) (80% argon (Ar) and 20% krypton (Kr)) at 400 Pa as buffer gas are enclosed. Note that the buffer gas is not limited to the above mixed gas. The buffer gas can be, for example, single gas such as argon, neon (Ne), krypton or the like, or mixed gas which is a mixture of the stated gases.

The dimensions in a typical structure of the lamp 1 are as follows. As to the arc tube 10, the inner tube diameter of a main body is 6.4 mm, an outer tube diameter is 8.0 mm and the distance between electrodes is 480 mm. The height of the convex part 23 of the swollen part 22 is 2 mm. As to the double helical-shaped bent glass tube 11, a gap between adjacent winds of the tube is 1.0 mm, the number of windings is about 5.25 turns, an outer diameter φao is 36.5 mm and a total length La is 63 mm. As to the form of an outer periphery of the lamp 1, an outer diameter Do of the outer tube bulb 31 is 55 mm and a total lamp length Lo is 110 mm.

As with the conventional lamp, the lamp 1 has an outer diameter Do of 55 mm and a total lamp length Lo of 110 mm. However, since an outer tube diameter of the arc tube 10 becomes thinner from 9.0 mm (conventional outer diameter) to 8.0 mm, the distance between electrodes is 480 mm which is 1.2 times longer than a conventional distance between electrodes. Thus, the lamp 1 has a luminous flux of 810 lm although the power consumption is 10 W.

Next, the structures of the electrodes 15 and 16 are described in detail. Also, since the electrodes 15 and 16 have the same structure, only the structure of the electrode 15 is described.

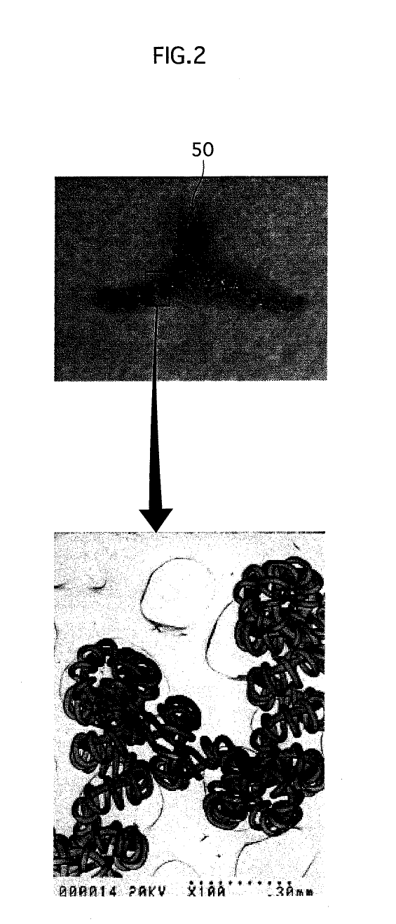

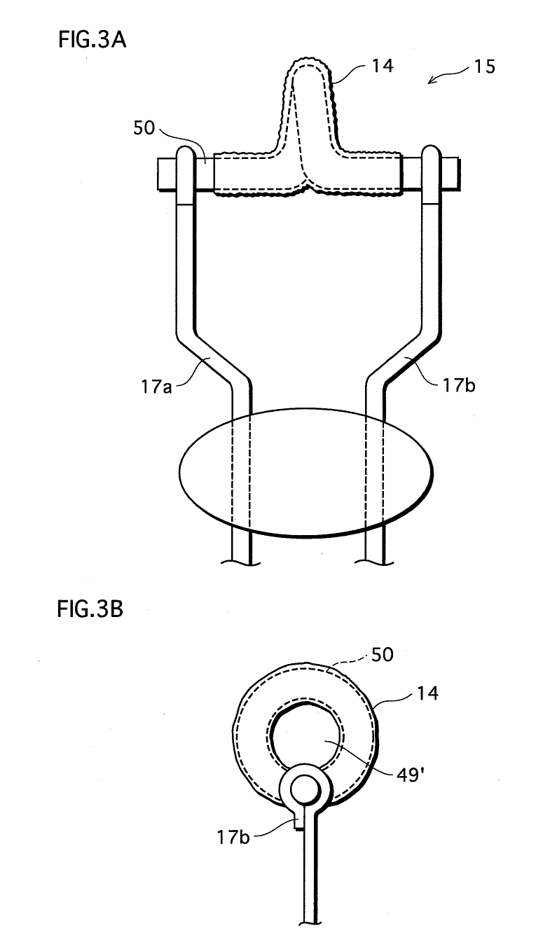

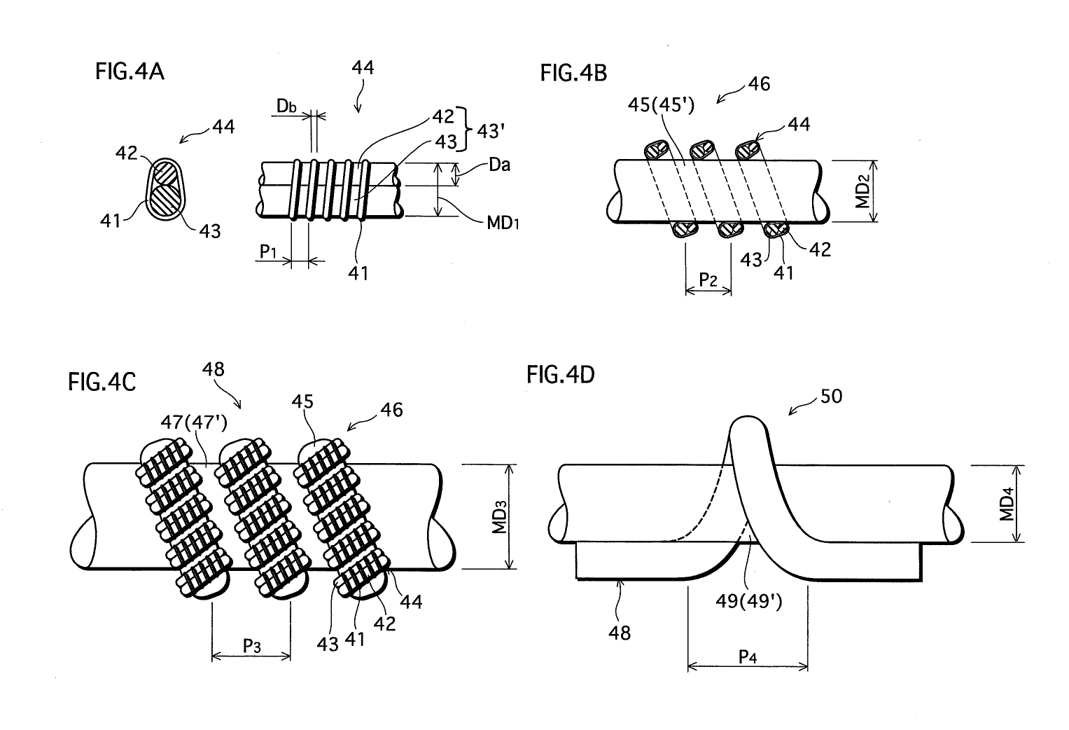

FIG. 2 shows the quadruple coil pertaining to the first embodiment. FIGS. 3A and 3B show an electrode for a discharge lamp pertaining to the first embodiment with FIG. 3A showing a front elevational view and FIG. 3B showing a side view. FIGS. 4A, 4B, 4C and 4D show coiling processes of the quadruple coil pertaining to the first embodiment with FIG. 4A, FIG. 4B, FIG. 4C and FIG. 4D showing a first winding step, a secondary winding step, a third winding step and a quaternary winding step, respectively.

The electrode 15 includes a quadruple coil 50 as shown in FIG. 2. The quadruple coil 50 has the packing capacity for electron emitting material larger than the packing capacity for the triple coil although the quadruple coil 50 has the same size (coil length CL) as the conventional triple coil. Accordingly, the rated life of the lamp 1 is 10,000 hours, which is longer than the rated life of the conventional lamp (6,000 hours).

As shown in FIGS. 3A and 3B, the quadruple coil 50 is packed with electron emitting material 14. Firstly, the electrodes 15 and 16 are applied with and packed with the electron emitting material 14 in the form of complex carbonate of alkaline earth metals Ba—Sr—Ca including zirconium oxide. Next, the complex carbonate is converted to composite oxide by a so-called decomposition process.

As shown in FIG. 3A, a vicinity of caulking parts of the electrode lead lines 17a and 17b of the quadruple coil 50 is not packed with the electron emitting material 14. This is because an adequate temperature rise of the electron emitting material 14 cannot be expected in an electrode decomposition process at the time of manufacturing a lamp even if the vicinity of the caulking parts are packed with the electron emitting material 14.

As shown in FIG. 3B, in the quadruple coil 50, a hollow space 49′ surrounded by a quaternary winding is packed with little electron emitting material 14. As described below, since the number of windings in a quaternary winding is one turn, the length of the hollow space 49′ surrounded by the quaternary winding in a winding axis direction is insufficient. Therefore, even if the hollow space 49′ surrounded by the quaternary winding is packed with the electron emitting material 14, the electron emitting material 14 might fall off due to impact and vibration caused in transporting a lamp.

Next, a description is given of a method for manufacturing the quadruple coil 50.

Firstly, a coiling process of manufacturing the quadruple coil 50 by coiling a filament is described. The quadruple coil 50 is made by performing a first winding of a filament to make a single coil, performing a secondary winding of the single coil to make a double coil, performing a tertiary winding of the double coil to make a triple coil and performing a quaternary winding of the triple coil.

The coiling process has the following four steps. Firstly, as shown in FIG. 4A, a secondary wire 41 (filament) made of tungsten is wound around a main line 42 (second filament) made of tungsten and a first core 43 made of molybdenum to make a single coil 44. Next, as shown in FIG. 4B, the single coil 44 is wound around a second core 45 made of molybdenum to make a double coil 46. Next, as shown in FIG. 4C, the double coil 46 is wound around a third core 47 made of molybdenum to make a triple coil 48. Next, as shown in FIG. 4D, the triple coil 48 is wound one turn around a fourth core 49 made of molybdenum to make a quadruple coil 50.

Next, cores 43, 45, 47 and 49 made of molybdenum are melted so as to be removed in a melting process. Specifically, the quadruple coil 50 is immersed in mixed acid solution with the quadruple coil 50 wound around the cores 43, 45, 47 and 49. Then only the cores 43 45, 47 and 49 are melted so as to be removed in the mixed acid solution.

In the quadruple coil 50 after the melting process is complete, space where the first core 43 existed, space where the main line 42 exists and the like are collectively called a hollow space 43′ surrounded by a first winding. Space where the second core 45 existed is called a hollow space 45′ surrounded by a secondary winding. Space where the third core 47 existed is called a hollow space 47′ surrounded by a tertiary winding. Space where the fourth core 49 existed is called a hollow space 49′ surrounded by a quaternary winding.

A mandrel diameter MD₁ of the first winding is substantially the same as a sum of a diameter of the first core 43 and a diameter Da of the main line 42. A mandrel diameter MD₂ of the secondary winding is substantially the same as a diameter of the second core 45. A mandrel diameter MD₃ of the tertiary winding is substantially the same as a diameter of the third core 47. A mandrel diameter MD₄ of the quaternary winding is substantially the same as a diameter of the fourth core 49.

Being made of tungsten, the main line 42 does not melt in the mixed acid solution. Therefore, the main line 42 remains, while passing through the hollow space 43′ surrounded by the first winding. That is, the secondary wire 41 that composes the single coil 44 is wound around the main line 42 as a basket line. Also, although the secondary wire 41 that composes the single coil 44 works as a basket line in the above, it is possible to have a structure in which the secondary wire 41 that composes the double coil 46 and the triple coil 48 works as a basket line. Such structure also makes it possible to stably maintain the shape of the quadruple coil 50.

Next, the quadruple coil 50 is packed with the electron emitting material 14 after fixing the quadruple coil 50 to the electrode lead lines 17a and 17b by so-called caulking. Specifically, the quadruple coil 50 is packed with the electron emitting material 14 by applying suspension of the electron emitting material 14 to the quadruple coil 50 and then drying the suspension. Thus, each of the hollow space 43′ surrounded by the first winding, the hollow space 45′ surrounded by the secondary winding and the hollow space 47′ surrounded by the tertiary winding is packed with the electron emitting material 14. Also, the electron emitting material 14 is attached on the surfaces of the secondary wire 41 and the main line 42.

Note that at least the hollow space 47′ surrounded by the tertiary winding simply needs to be packed with the electron emitting material 14. In some cases, the hollow space 43′ surrounded by the first winding and the hollow space 45′ surrounded by the secondary winding do not have to be packed with the electron emitting material 14. This is because it is possible to ensure a larger packing capacity than the packing capacity of the conventional triple coil as long as the hollow space 47′ surrounded by the tertiary winding has the largest packing capacity, and is packed with the electron emitting material 14. Also, the hollow space 47′ surrounded by the tertiary winding as a whole does not have to be packed with the electron emitting material 14, and a part of the hollow space 47′ surrounded by the tertiary winding may be packed with the electron emitting material 14.

Hereinafter, the feature of the quadruple coil pertaining to the present invention is described.

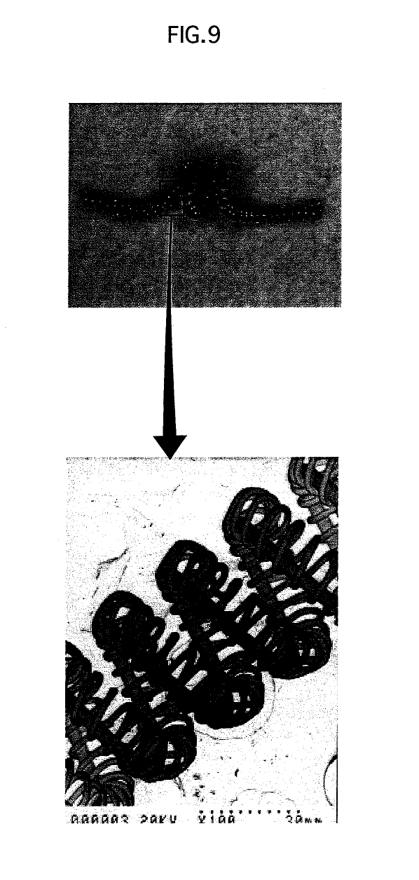

As to a conventional triple coil (comparative example) as shown in FIG. 9, the number of windings in a tertiary winding is limited to about 1 turn in order to downsize an electrode. Also, in order to avoid contact between filaments due to a flexure, there is a limit to how big the mandrel diameter can be. Therefore, it is difficult to further increase the packing capacity for electron emitting material of the conventional triple coil.

In order to solve this problem, although the quadruple coil pertaining to the present invention has substantially the same size as the conventional triple coil, the number of windings in the tertiary winding is 20 turns or more (for example, the number of windings in the tertiary winding of the quadruple coil 50 in the first embodiment is 27 turns). That is, since the length of the hollow space surrounded by the tertiary winding in the winding axis direction is long, the hollow space surrounded by the tertiary winding can also be packed with the electron emitting material, too. Therefore, the packing capacity for electron emitting material is notably large compared to the conventional triple coil in which only the hollow space surrounded by the first winding and the hollow space surrounded by the secondary winding can be packed with the electron emitting material. Specifically, the packing amount is 1.5 to 2.0 times larger compared to the conventional triple coil. As a result, the rated life of a lamp is extended from 6,000 hours (a conventional rated life of a lamp) to more than 10,000 hours.

In order to achieve an adequate effect of extending lamp life which is realized by increasing the packing capacity for electron emitting material, the following structures are needed: a structure in which the electron emitting material does not easily falls off from the quadruple coil, and a structure in which the electron emitting material as a whole is heated evenly by the heat of a filament. This is because it is not possible to expect an extension of life of a steady lamp even if the packing amount of electron emitting material increases if the electron emitting material easily falls off from the quadruple coil due to impact and vibration caused in transporting a lamp. Also, in order to decrease a work function φe that is for an electrode to emit electrons, free barium needs to be appropriately generated from the electron emitting material. However, in order for that, it is necessary to evenly heat the electron emitting material as a whole at an appropriate temperature. Also, the electron emitting material does not contribute to the extension of lamp life efficiently if excessively heated or insufficiently heated parts exist.

The above problems are an obstacle to achieving extended lamp life that is the object of the present invention. In order to solve the above two problems and to achieve an adequate effect of extending lamp life by increasing the amount of electron emitting material, the present inventors studied the specific optimum range of the size of an electrode.

As a result, it was found that in particular conditions of the tertiary winding are most important. Specifically, it was found that it is possible to deal with the above problems if a mandrel diameter MD₃ of the tertiary winding is in the range of 0.15 to 0.45 mm and a coil pitch P₃ is 1.2 to 2.4 times larger than the mandrel diameter MD₃.

Note that if the mandrel diameter MD₃ is larger than 0.45 mm, the heat of a filament does not sufficiently conduct to electron emitting material far from the filament, making it difficult to generate free barium from the electron emitting material. As a result, the effect of extending lamp life is reduced. On the other hand, if the mandrel diameter MD₃ is smaller than 0.15 mm, a hollow space surrounded by the tertiary winding becomes too narrow and the packing capacity for electron emitting material is little different from the conventional triple coil.

Therefore, it is not possible to achieve an adequate effect of extending lamp life when the mandrel diameter MD₃ is too large or too small. Thus, it is preferable that the mandrel diameter MD₃ is in the range of 0.15 to 0.45 mm.

Next, if the coil pitch P₃ of the tertiary winding is less than 1.2 times larger than the mandrel diameter MD₃, the distance between filaments that are adjacent to each other becomes too short. Therefore, an electrical short easily occurs between those filaments. Thus an adequate amount of free barium might not be generated in manufacturing. As a result, problems such as shortening of lamp life and the like might arise.

Also, if the coil pitch P₃ is more than 2.4 times larger than the mandrel diameter MD₃, the distance between filaments that are adjacent to each other becomes too long. Therefore, the electron emitting material easily falls off. As a result, problems such as the shortening of lamp life and the like might arise since the electron emitting material easily falls off from a coil due to impact and vibration caused in transporting a lamp. Therefore, it is preferable that the coil pitch P₃ is 1.2 to 2.4 times larger than the mandrel diameter MD₃.

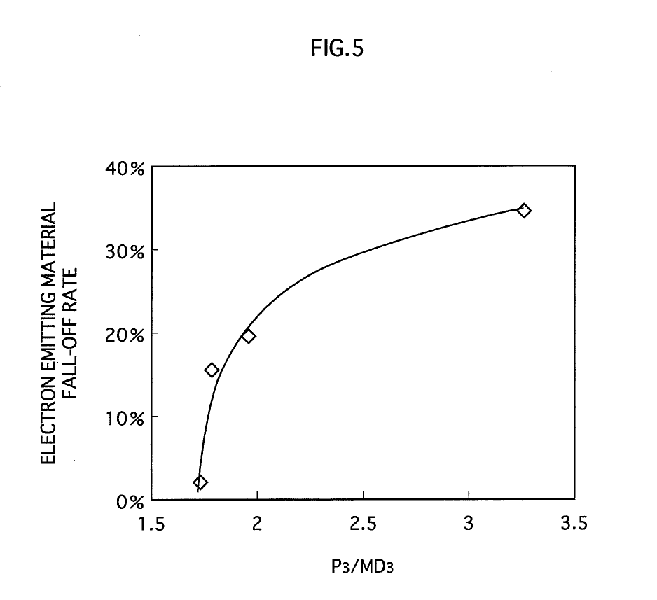

FIG. 5 is a graph showing a relationship between P₃/MD₃ and a fall-off rate of the electron emitting material. As shown in FIG. 5, four types of coils are manufactured with a ratio between the coil pitch P₃ and the mandrel diameter MD₃ being a parameter. The graph also shows how easy electron emitting material falls off. A horizontal axis shows the ratio between the coil pitch P₃ and the mandrel diameter MD₃ (i.e. P₃/MD₃). On the other hand, the vertical axis shows the fall-off rate of the electron emitting material.

The fall-off rate is obtained as follows. Firstly, a lamp is manufactured using a coil to be measured. Next, the lamp is destroyed in a way that the electron emitting material does not fall off due to impact in destroying. Then the coil is taken out. After that, the weight of the coil is measured (the weight of the coil before a test: W1). Furthermore, the weight of the coil is measured again after performing a drop impact test using the coil whose weight has been measured (the weight of the coil after the test: W2). Also, all the attached electron emitting material is removed from the coil using acid, and the weight of the coil after the removal is measured (the weight of the coil after removing the electron emitting material: W3). Then, the fall-off rate is calculated by the following formula.

(fall-off rate)=(W1−W2)/(W1−W3)

FIG. 5 shows the plotted result of the fall-off rate obtained experimentally in such way. It is known from experience that if the fall-off rate exceeds 30%, the electron emitting material easily falls off, which affects lamp life. Therefore, it can be judged from the graph in FIG. 5 that it is possible to keep the fall-off rate to 30% or less if P₃/MD₃ is 2.4 or less, and as a result, it is possible to prevent the electron emitting material from falling off due to impact and vibration caused in transporting a lamp.

Next, as the number of windings in the tertiary winding increases, it is possible to pack a lot of electron emitting material. However, an overall resistance value becomes too large since a coil length CL becomes longer. As a result, a difference in potential between electrode lead lines becomes large when applying a desired amount of current, which causes a discharge. In order to solve this problem, a structure is made such that the main line passes through the hollow space surrounded by the first winding of the secondary wire as a basket line, and the relation of Db<Da<1.5 Db is satisfied when a diameter of the main line is expressed as Da and a diameter of the secondary wire is expressed as Db.

If such relation is satisfied, a current appropriately splits and flows through the main line and the secondary wire. Therefore, even if the coil length CL becomes longer, the total resistance value does not increase a lot. Therefore, a discharge does not occur between electrode lead lines even if the number of windings in the tertiary winding is 20 turns or more. Also, as to the quadruple coil 50 pertaining to the first embodiment, a diameter of the main line 42 Da is 0.028 mm and a diameter of the secondary wire 41 Db is 0.020 mm.

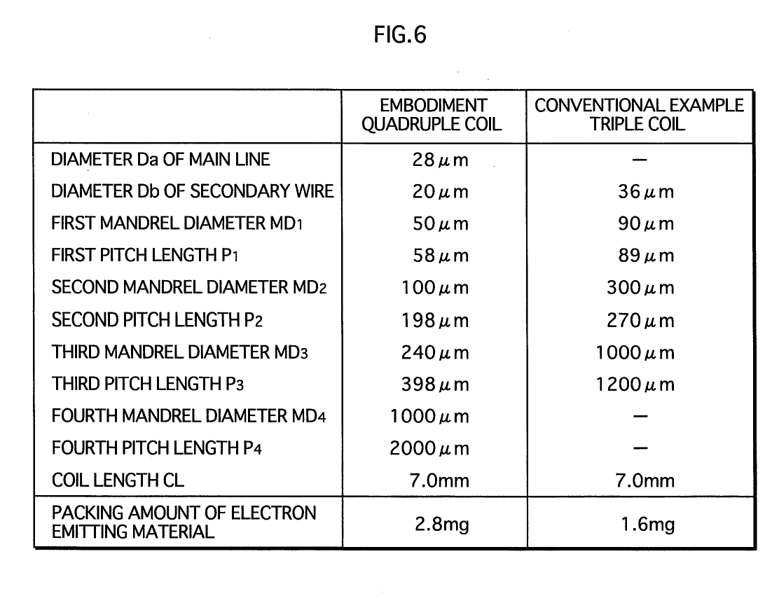

The lamp 1 including the electrodes 15 and 16 pertaining to the first embodiment was manufactured, and life tests and measuring of characteristics was carried out. FIG. 6 shows a comparison between specifications of the quadruple coil pertaining to the present invention and specifications of the conventional triple coil.

As shown in FIG. 6, the filing amount of the electron emitting material 14 of the quadruple coil 50 is 2.8 mg, which means the packing amount has increased by 70% compared to the packing amount of the conventional triple coil which is 1.6 mg. Thus, the rated life of the lamp 1 is extended from 6,000 hours (the conventional rated life of a lamp) to more than 10,000 hours.

Also, although the lamp 1 is substantially the same size as a general incandescent lamp (60 W), the efficiency is 81 lm/W (an input wattage of 10 W and a luminous flux of 810 ml), which achieves marked power saving compared to 60 W lamp (810/60=13.5 lm/W) and a conventional bulb-type fluorescent lamp (810/12=67.5 lm/W).

### Second Embodiment

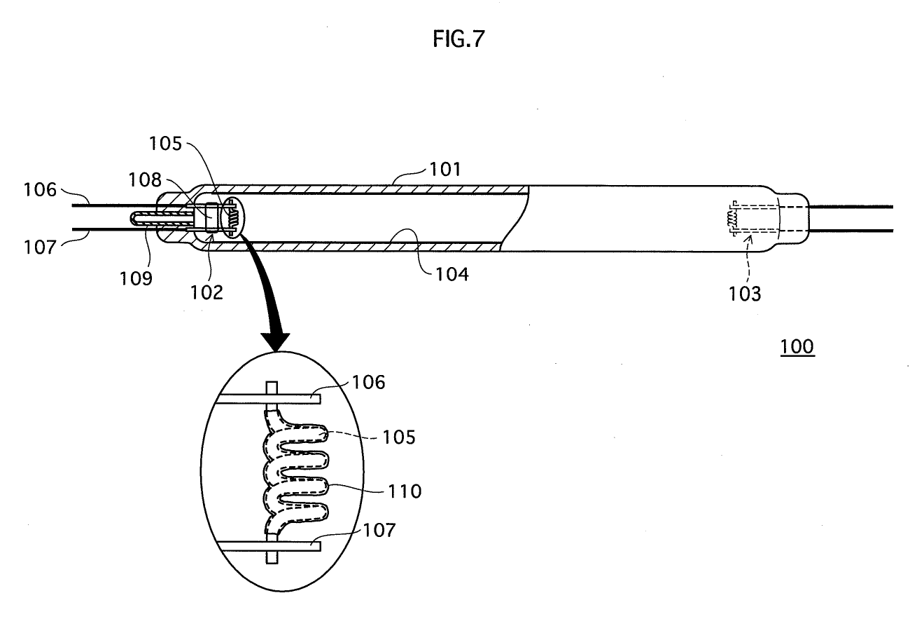

FIG. 7 is a partially broken view showing a structure of a lamp having electrodes for a discharge lamp pertaining to a second embodiment.

As shown in FIG. 7, a discharge lamp 100 (hereinafter, “lamp 100”) is a low-pressure mercury discharge lamp and includes a glass tube 101 and hot cathode type electrodes 102 and 103 sealed at both ends of the glass tube 101.

The glass bulb 101 has, for example, an external diameter of 18 mm, a wall thickness of 0.8 mm and a length of 1010 mm. In addition to mercury (for example, 4 mg to 10 mg) as light emitting material, mixed gas of argon and krypton (50%:50%) as buffer gas at a gas pressure of 600 Pa, for example, is enclosed in the glass bulb 101.

A phosphor layer 104 that converts ultraviolet rays emitted by mercury into visible light is formed in the inner surface of glass bulb 101. The phosphor layer 104 is, for example, composed of a rare earth phosphor formed from a mixture of a red phosphor (Y₂O₃: Eu), a green phosphor (LaPO₄: Ce, Tb) and a blue phosphor (BaMg₂Al₁₆O₂₇: Eu, Mn).

Since an electrode 102 and an electrode 103 have the same structure, only the structure of the electrode 102 is described. A so-called bead glass mounting method is adopted for the electrode 102. Also, the electrode 102 includes a quadruple coil 105 made of tungsten, a pair of lead lines 106 and 107 that support the quadruple coil 105, and a bead glass 108 that integrally fixes this pair of lead lines 106 and 107.

The electrode 102 is sealed to the glass tube 101 at a part of each of the lead lines 106 and 107 (specifically, a portion extending from the bead glass 108 in the direction opposite to the quadruple coil 105). Also, the electrode 102 is sealed to the glass tube 101 by pinch sealing, for example.

Note that an exhaust tube 109 is provided together with the electrode 102 at one end of the glass tube 101 (here, an end on the side at which the electrode 102 the glass tube 101 is provided). The exhaust tube 109 is used in exhausting gas from the glass tube 101, and enclosing the above buffer gas or the like after sealing the electrode 106, the electrode 107 and the like. On completion of enclosing the buffer gas or the like in the glass tube 101, tip-off sealing, for example, is performed at a part of the exhaust tube 109 positioned outside the glass tube 101.

Next, the quadruple coil 105 is described in detail. The quadruple coil 105 pertaining to the second embodiment basically has the same structure as the quadruple coil 50 pertaining to the first embodiment. Accordingly, the description focuses on the parts of the structure that differ, with a description of the common parts of the structure being kept brief or omitted.

The quadruple coil 105 is made by performing a first winding of a filament to make a single coil, performing a secondary winding of the single coil to make a double coil, performing a tertiary winding of the double coil to make a triple coil and performing a quaternary winding of the triple coil. Also, a main line is provided in a hollow space surrounded by the first winding so as to pass though the hollow space surrounded by the first winding.

As to a measurement of each part of the quadruple coil, a diameter of the main line Da is 70 μm, a diameter of a secondary wire Db is 50 μm, a first mandrel diameter MD₁ is 90 μm, a first pitch length P₁ is 89 μm, a second mandrel diameter MD₂ is 200 μm, a second pitch length P₂ is 381 μm, a third mandrel diameter MD₃ is 398 μm, a third pitch length P₃ is 710 μm, a fourth mandrel diameter MD₄ is 1500 μm and a fourth pitch length P₄ is 1800 μm.

Alternatively, a measurement of each part of the quadruple coil may be as follows. For example, as to a measurement of each part of the quadruple coil, a diameter of the main line Da is 90 μm, a diameter of a secondary line Db is 20 μm, a first mandrel diameter MD₁ is 90 μm, a first pitch length P₁ is 89 μm, a second mandrel diameter MD₂ is 200 μm, a second pitch length P₂ is 381 μm, a third mandrel diameter MD₃ is 398 μm, a third pitch length P₃ is 710 μm, a fourth mandrel diameter MD₄ is 1200 μm and a fourth pitch length P₄ is 1800 μm.

In the quadruple coil 105, each of the hollow space surrounded by the first winding, a hollow space surrounded by the secondary winding and a hollow space surrounded by the tertiary winding is packed with an electron emitting material 110. Also, the electron emitting material 14 is attached on each surface of the main line 41 and the secondary wire 42.

As to the quadruple coil 105, the packing amount of the electron emitting material 110 is 60 mg which is 12 times the packing amount of electron emitting material of a triple coil mounted on a conventional low-pressure mercury discharge lamp. Thus, the rated life of the lamp 100 is extended from 10,000 hours (a conventional rated life of a lamp) to more than 120,000 hours.

Also, the packing amount of the electron emitting material 110 of the quadruple coil 105 can be 15 mg to 60 mg in accordance with required lifetime. In this case, the rated life of the lamp 100 is 30000 to 120000 hours.

(Modification)

Hereinbefore, the electrode for a discharge lamp and the discharge lamp that pertain to the present invention are specifically described based on the embodiments. However, the present invention is not limited to the above embodiments.

In addition to the lamps pertaining to the above embodiments, the electrode pertaining to the present invention works effectively for, for example, a lamp having a comparatively thin arc tube whose inner tube diameter is 6 mm or less. Thus, it is possible to provide a power saving, long life and more compact bulb-type fluorescent lamp.

The quadruple coil pertaining to the present invention is not limited to a coil whose number of windings in the quaternary winding is 1 turn like the quadruple coil 50 pertaining to the first embodiment or a coil whose number of windings in the quaternary winding is 4 turns like the quadruple coil 105 pertaining to the second embodiment. Therefore, the number of windings in the quaternary winding does not matter as long as the size of an electrode allows the electrode to be structured to be fit in an arc tube. Also, the number of windings is not limited to a natural number as long as the number of windings is a decimal which is 0 or more. That is, a mixed decimal such as 2.5 turns or a pure decimal such as 0.5 turns are possible.

Furthermore, the electrode pertaining to the present invention is not limited to an electrode including a quadruple coil, and an electrode including a bent triple coil is possible. Here, the bent triple coil means a coil which is made by performing a winding of a filament to make a single coil, performing a secondary winding of the single coil to make a double coil, performing a tertiary winding of the double coil to make a triple coil, and further bending the triple coil.

A shape into which a triple coil is bent can be any shape, for example, a substantially Ω shape, a substantially M shape, a substantially inverted U shape, substantially inverted V shape, a spiral shape or the like as long as a coil length CL can be kept short and the number of windings in the tertiary winding can be increased.

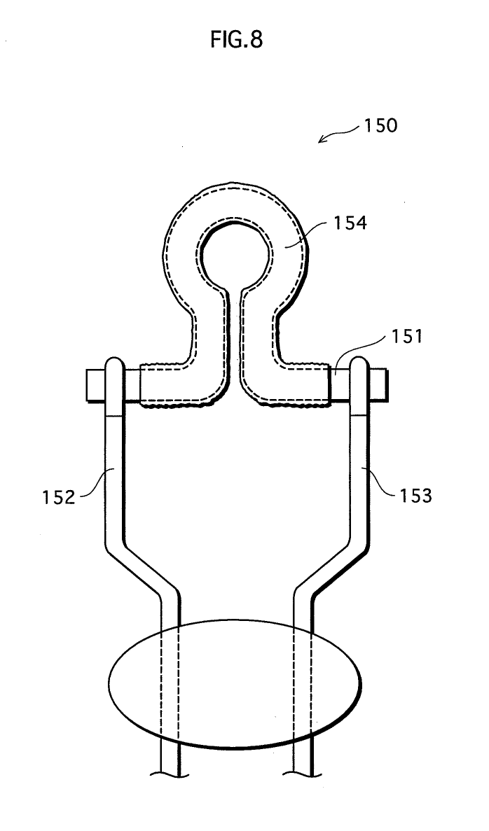

FIG. 8 shows an electrode for a discharge lamp pertaining to a modification. For example, an electrode 150 shown in FIG. 8 includes a bent triple coil 151 which is made by bending a triple coil into a substantially Ω shape. The bent triple coil 151 is made by making a tungsten filament into a triple coil in the same process as the coiling process pertaining to the first embodiment, and further bending the triple coil into a substantially Ω shape. The bent triple coil 151 basically has the same structure as the quadruple coil 50 of the first embodiment except that the triple coil is bent instead of performing the quaternarily winding of the triple coil. The bent triple coil 151 is supported by a pair of electrode lead lines 152 and 153 using a bead mounting method.

The bent triple coil 151 is made by further bending a triple coil. Therefore, although a distance between the electrode lead lines 152 and 153 is the same, the number of windings in the tertiary winding is large compared to the conventional triple coil which is not bent. Therefore, it is possible to increase the length of the hollow space surrounded by the tertiary winding in the winding axis direction without increasing the size of a coil (coil length CL). Also, the hollow space surrounded by the tertiary winding can be packed with more electron emitting material.

Also, as to the bent triple coil 151, it is preferable that the mandrel diameter MD₃ of the tertiary winding is 0.15 to 0.45 mm like the quadruple coil 50 pertaining to the first embodiment. With this structure, it is possible to heat evenly the electron emitting material as a whole at the time of discharge with the adequate packing capacity for electron emitting material ensured. Thus is it possible to extend lamp life more effectively.

Also, according to the bent triple coil 151, it is preferable that, in the tertiary winding, a coil pitch P₃ is larger than the mandrel diameter MD₃ by 1.2 to 2.4 times. With this structure, it is possible to extend lamp life more effectively.

Also, according to the bent triple coil 151, a second filament which is provided in addition to the filament may be arranged so as to pass through at least one of a hollow space surrounded by a first winding, a hollow space surrounded by a second winding and the hollow space surrounded by a tertiary winding in the quadruple coil. With such structure, it is possible to stably maintain the shape of the quadruple coil. Therefore, it is possible to obtain an electrode which is made such that the electron emitting material hardly falls off and an electrical short does not occur much.

Also, as to the bent triple coil 151, it is preferable that a diameter Da of the second filament and a diameter Db of the filament of the quadruple coil satisfy a relation of Db<Da<1.5 Db. With this structure, a current appropriately splits and flows through each of the filament that composes the quadruple coil and the second filament. Also, a discharge does not happen between electrode lead lines. Therefore, a discharge does not occur between the electrode lead lines.

Also, as to the bent triple coil 151, it is preferable that a number of windings in the tertiary winding is 20 turns or more. With this structure, the hollow space surrounded by the tertiary winding can be packed with the adequate packing amount of electron emitting material.

### INDUSTRIAL APPLICABILITY

The electrode for a discharge lamp pertaining to the present invention can be applied to a compact fluorescent lamp that has been popular in recent years as a power saving light source together with a bulb-type fluorescent lamp. Also, by increasing the number of windings in the tertiary winding, for example, the electrode for a discharge lamp pertaining to the present invention basically can be applied to various fluorescent lamps for general illumination and to other lamps including a compact hot-cathode type fluorescent lamp which is an alternative to a conventional compact cold-cathode fluorescent lamp as a power saving light source for a liquid crystal back light. That is, it is possible to markedly extend not only the life of a compact lamp but also the life of a large-size lamp.

1. An electrode for a discharge lamp, the electrode including a quadruple coil which is made by performing a first winding of a filament to make a single coil, performing a secondary winding of the single coil to make a double coil, performing a tertiary winding of the double coil to make a triple coil and performing a quaternary winding of the triple coil, wherein
in the quadruple coil, at least a hollow space surrounded by the tertiary winding is packed with an electron emitting material.

2. The electrode for a discharge lamp of claim 1, wherein
the tertiary winding of the quadruple coil has a mandrel diameter MD₃ of 0.15 mm to 0.45 mm.

3. The electrode for a discharge lamp of claim 2, wherein
in the tertiary winding of the quadruple coil, a coil pitch P₃ is larger than the mandrel diameter MD₃ by 1.2 to 2.4 times.

4. The electrode for a discharge lamp of claim 3, wherein
a second filament which is provided in addition to the filament is arranged so as to pass through at least one of a hollow space surrounded by the first winding, a hollow space surrounded by the secondary winding and the hollow space surrounded by the tertiary winding in the quadruple coil.

5. The electrode for a discharge lamp of claim 4, wherein
a diameter Da of the second filament and a diameter Db of the filament of the quadruple coil satisfy a relation of Db<Da<1.5 Db.

6. The electrode for a discharge lamp of claim 5, wherein
a number of windings in the tertiary winding of the quadruple coil is 20 turns or more.

7. An electrode for a discharge lamp, the electrode including a bent triple coil which is made by performing a first winding of a filament to make a single coil, performing a secondary winding of the single coil to make a double coil, performing a tertiary winding of the double coil to make a triple coil and bending the triple coil, wherein
in the quadruple coil, at least a hollow space surrounded by the tertiary winding is packed with an electron emitting material.

8. The electrode for a discharge lamp of claim 7, wherein
the tertiary winding of the bent triple coil has a mandrel diameter MD₃ of 0.15 to 0.45 mm.

9. The electrode for a discharge lamp of claim 8, wherein
in the tertiary winding of the bent triple coil, a coil pitch P₃ is larger than the mandrel diameter MD₃ by 1.2 to 2.4 times.

10. The electrode for a discharge lamp of claim 9, wherein
a second filament which is provided in addition to the filament is arranged so as to pass through at least one of a hollow space surrounded by the first winding, a hollow space surrounded by the secondary winding and the hollow space surrounded by the tertiary winding in the quadruple coil.

11. The electrode for a discharge lamp of claim 10, wherein
a diameter Da of the second filament and a diameter Db of the filament of the bent triple coil satisfy a relation of Db<Da<1.5 Db.

12. The electrode for a discharge lamp of claim 11, wherein
a number of windings in the tertiary winding of the bent triple coil is 20 turns or more.

13. A discharge lamp including the electrode for a discharge lamp of claim 1.

14. The discharge lamp of claim 13, being a bulb-type fluorescent lamp.

15. The discharge lamp of claim 13, being a light source for a liquid crystal backlight.

16. A discharge lamp including the electrode for a discharge lamp of claim 7.

17. The discharge lamp of claim 16, being a bulb-type fluorescent lamp.

18. The discharge lamp of claim 16, being a light source for a liquid crystal backlight.
